(19) United States
(12) Patent Application Publication
(10) Pub. No.: US 2005/0094907 A1
(43) Pub. Date: May 5, 2005

(54) Fluid dynamic bearing motor

(75) Inventor: Sang Uk Kim, Seoul (KR)

Correspondence Address: Robert E. Krebs;THELEN REID & PRIEST LLP, P.O. BOX 640640, SAN JOSE, CA, 95164-0640, US

(73) Assignee: G & W Technologies, Inc.

(21) Appl. No.: 10/981,960

(22) Filed: Nov. 4, 2004

(30) Foreign Application Priority Data
Nov. 5, 2003 (KR) 2003-78044
Jun. 16, 2004 (KR) 2004-44511

(51) Int. Cl. F16C 33/74; F16C 32/06

(52) U.S. Cl. 384/107

(57) ABSTRACT

Provided is a fluid dynamic bearing motor including a housing fixing a core wound with a coil and a sleeve having a shaft hole at a center thereof, a shaft rotatably coupled to the shaft hole and forming an oil gap, a hub fixed to an upper end portion of the shaft and having a magnet attached to an inner circumferential surface of the hub and generating an electromagnetic force with the core, and a circular thrust plate coupled to an upper portion of the shaft and forming dynamic pressure in a thrust direction with the sleeve.

### BACKGROUND OF THE INVENTION

This application claims the priority of Korean Patent Application No. 2003-78044, filed on Nov. 5, 2003, and Korean Patent Application No. 2004-44511, filed on Jun. 16, 2004, in the Korean Intellectual Property Office, the disclosure of which is incorporated herein in their entirety by reference.

1. Field of the Invention

The present invention relates to a fluid dynamic bearing motor, and more particularly, to a fluid dynamic bearing motor having an improve structure to reduce an increase in temperature of oil by effectively distributing heat generated during driving the motor. Also, the present invention relates to a fluid dynamic bearing motor which has an improved load support capability corresponding to an increased load as a plurality of platters are adopted to enable recording and/or storing of a large amount of information.

2. Description of the Related Art

In general, a fluid dynamic bearing has an oil gap formed between a rotor and stator of a motor and the oil gap is filled with oil having a predetermined viscosity. During rotation of the rotor, the oil in the oil gap is compressed to form a fluid dynamic pressure so that the rotor is rotatably supported.

FIG. 1 shows an example of a motor adopting a fluid dynamic bearing. Referring to FIG. 1, a shaft rotating type motor includes a stator having a housing 10, a sleeve 20, and a core 30, and a rotor having a shaft 40, a hub 50, and a magnet 60.

The sleeve 20 has a hollow in which the shaft 40 is rotatably inserted and an oil groove (not shown) generating a dynamic pressure as oil flows in is formed in an inner circumferential surface thereof. A circular thrust plate 70 is coupled to a lower end portion of the shaft 40 to be capable of rotating with the shaft 40. The core 30 wound with a coil is fixed at the center portion of the housing 10. A groove (not shown) for generating a fluid dynamic pressure is formed in each of upper and lower surfaces of the thrust plate 70 so that the fluid dynamic pressure is generated in an axial direction.

A cover plate 80 rotatably supporting the thrust plate 70 and the lower end portion of the shaft 40 is coupled to a lower end portion of the sleeve 20. The hub 50 is integrally coupled with an upper end portion of the shaft 40. The hub 50 has a cap shape having an open bottom side and the magnet 60 is installed at an inner circumferential surface of an extended end portion of the hub 50 to face an outer circumferential surface of the core 30.

In the conventional shaft rotating type fluid dynamic bearing motor configured as above, when external power is applied to the core 30, the hub 50 having the magnet 60 attached thereto is rotated by an electromagnetic force generated between the core 30 and the magnet 60 so that the hub 50 and the shaft 40 coupled to the hub 50 rotate at the same time.

During driving of the motor, the shaft 40 rotatably coupled to an inner circumferential portion of the sleeve 20 can smoothly rotate without contacting an inner circumferential surface of the sleeve 20 by a fluid dynamic pressure in a radial direction generated in an oil groove (not shown) formed in the inner circumferential surface of the sleeve 20 or an outer circumferential surface of the shaft 40. Also, a fluid dynamic pressure in a thrust direction is generated among the thrust plate 70, the sleeve 20, and the cover plate 80 so that the shaft 40 is rotatably supported.

However, the motor adopting the fluid dynamic bearing configured as above has the following drawbacks.

First, during driving of the motor, heat is generated by an electromagnetic characteristic of the core 30 and the magnet 60. Also, mechanical friction heat is generated due to a relative velocity between the rotor and the stator constituting the fluid dynamic bearing. In particular, since the relative velocity increases in the sleeve 20 and the thrust plate 70 whose diameters are greater than the shaft, generation of heat increases. Thus, due to the generation of heat in the thrust plate 70 forming a fluid dynamic bearing surface, the temperature of oil increases. Accordingly, as the viscosity of oil decreases, the load support force of the fluid dynamic bearing decreases.

When the load support force decreases, a gap between fluid dynamic bearing surfaces narrows, which causes addition generation of heat. Also, since an electromagnetic heat generating source and a heat generating source by a mechanical friction are disposed close to each other, not only the life span of oil is reduced but also the driving characteristic of the motor is lowered due to a sharp decrease in the viscosity of the oil.

Second, a large amount of air bubbles exist in the oil provided in the oil gap. As the temperature of the air bubbles increases by friction heat generated in the oil gap at the initial stage of driving, the air bubbles thermally expand and the expanded air bubbles push the oil out of the oil gap, so that the oil leaks outside. In particular, in the motor configured as above, since the upper end portion of the sleeve 20 forming the fluid dynamic bearing surfaces with the shaft 40 is exposed to air connected to the inside of the hub 50, the oil between the sleeve 20 and the shaft 40 may leak by the internal pressure and also foreign materials can intrude through the upper end portion of the sleeve 20.

Third and the last, when the number of platters that are coupled to the hub 50 and rotate together is increased to obtain a large capacity hard disk drive, the amount of load to a rotating body, that is, the hub and the shaft, increases so that vibrations are generated.

### SUMMARY OF THE INVENTION

To solve the above and/or other problems, the present invention provides a fluid dynamic bearing motor in which the electromagnetic heat generating source and a heat generating source due to mechanical friction are separated from each other to reduce generation of heat so that deterioration of oil is reduced.

The present invention provides a fluid dynamic bearing motor which prevents leakage of oil according to an increase in the internal pressure and makes distribution of oil uniform by collecting air bubbles generated from an oil gap during driving of the motor.

The present invention provides a fluid dynamic bearing motor having an additional leakage preventing oil groove to prevent leakage of oil and increase the internal pressure.

The present invention provides a fluid dynamic bearing motor having an improved load support capability of a rotating body which enables stable driving even when the number of platters coupled to a hub and rotating together is increased to embody a large capacity hard disk drive (HDD).

According to an aspect of the present invention, a fluid dynamic bearing motor comprises a housing fixing a core wound with a coil and a sleeve having a shaft hole at a center thereof, a shaft rotatably coupled to the shaft hole and forming an oil gap, a hub fixed to an upper end portion of the shaft and having a magnet attached to an inner circumferential surface of the hub and generating an electromagnetic force with the core, and a circular thrust plate coupled to an upper portion of the shaft and forming dynamic pressure in a thrust direction with the sleeve.

The fluid dynamic bearing motor further comprises a cover coupled to the shaft, provided at an upper end of an inner circumferential portion of the sleeve, forming an oil gap with an upper surface of the thrust plate, and having a plurality of inclined grooves formed in an inner circumferential portion thereof at a predetermined interval.

A flow groove forming a passage for oil and generating dynamic pressure is formed in each of upper and lower surfaces of the thrust plate.

The flow groove has a herringbone shape or a spiral shape.

A storing groove storing oil and collecting air bubbles is formed in an inner circumferential portion of the thrust plate.

According to another aspect of the present invention, there is provided a fluid dynamic bearing motor in which a rotor is rotatably supported by a fluid dynamic bearing with respect to a stator, wherein the stator comprises a housing, a shaft fixed at a center portion of the housing, and a core wound with a coil and fixed to a lower end of the center portion of the housing, and the rotator comprises a sleeve rotatably coupled to the shaft and supported by the fluid dynamic bearing, a cover block coupled to an upper end of the sleeve and supporting the sleeve in a thrust direction, and a hub coupled to an outer circumferential surface of the sleeve to rotate together and having a magnet installed on an inner circumferential surface of a lower end thereof to face the core and forming an electromagnetic circuit.

According to another aspect of the present invention, there is provided a fluid dynamic bearing motor in which a rotor is rotatably supported by a fluid dynamic bearing with respect to a stator, wherein the stator comprises a housing fixed to a lower fixing body, a shaft having a lower end portion fixed at a center portion of the housing and an upper end portion fixed to the upper fixing body, a circular thrust plate fixed to an upper end portion of the shaft, and a core wound with a coil and fixed to a lower end of the center portion of the housing, and the rotator comprises a sleeve rotatably coupled to the shaft and supported by the fluid dynamic bearing, a fixing block coupled to an upper end of the sleeve, having a flow groove in an inner circumferential surface, and increasing pressure in the fluid dynamic bearing, and a hub coupled to an outer circumferential surface of the sleeve to rotate together and having a magnet installed on an inner circumferential surface of a lower end thereof to face the core and forming an electromagnetic circuit.

### BRIEF DESCRIPTION OF THE DRAWINGS

The above and other features and advantages of the present invention will become more apparent by describing in detail preferred embodiments thereof with reference to the attached drawings in which:

FIG. 1 is a cross-sectional view of a conventional fluid dynamic bearing motor;

FIG. 2 is a cross-sectional view of a fluid dynamic bearing motor according to an embodiment of the present invention;

FIG. 3 is a view illustrating a state in which oil flows during driving of the motor of FIG. 2;

FIG. 4 is a cross-sectional view of a dynamic pressure cover adopted in the motor of FIG. 2;

FIG. 5 is a plan view of a thrust plate adopted in the motor of FIG. 2;

FIG. 6 is a cross-sectional view showing an oil groove formed in an inner circumferential surface of a sleeve adopted in the motor of FIG. 2;

FIG. 7 is a cross-sectional view of a fluid dynamic bearing motor according to another embodiment of the present invention;

FIG. 8 is a cross-sectional view of a shaft fixed type fluid dynamic bearing motor according to an embodiment of the present invention; and

FIG. 9 is a cross-sectional view of a fixing block adopted in the motor of FIG. 8.

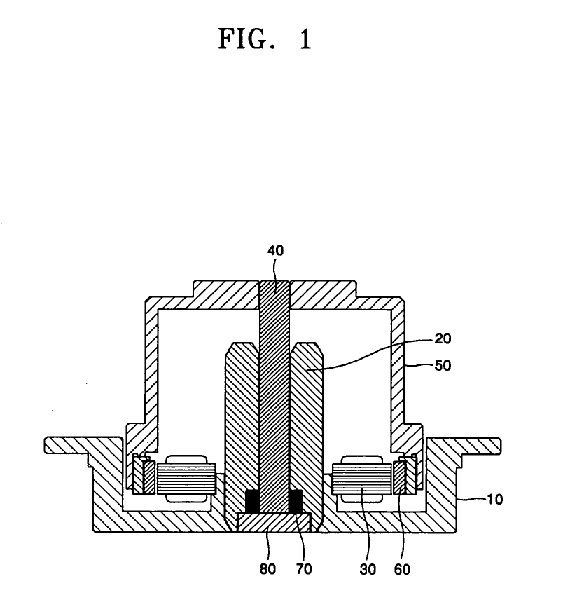

### DETAILED DESCRIPTION OF THE INVENTION

A fluid dynamic bearing motor according to an embodiment of the present invention adopts both a journal fluid dynamic bearing in which a fluid dynamic pressure is generated at a journal portion of a shaft facing a sleeve, and a thrust fluid dynamic bearing. In particular, in the fluid dynamic bearing motor according to the present embodiment, a heat generating source by an electromagnetic element and a heat generating source by mechanical friction are separated from each other so that the generated heat is dissipated smoothly.

Also, an upper end portion of the sleeve to which the shaft is rotatably coupled is coupled with a dynamic pressure cover that forms fluid dynamic pressure so that the internal pressure of a fluid dynamic bearing portion is increased and leakage of oil is effectively prevented. Also, in the fluid dynamic bearing, an oil storing portion or an air bubble collecting portion is provided at an area where pressure is low to store the oil during discontinuation of the operation thereof and collect fine air bubbles at a portion where the pressure is low during the operation thereof. Thus, the air bubbles expanding by the heat is effectively collected so that the leakage of oil is prevented and facilitates the driving of the motor.

The features of a fluid dynamic bearing motor according to an embodiment of the present invention will be described below in detail.

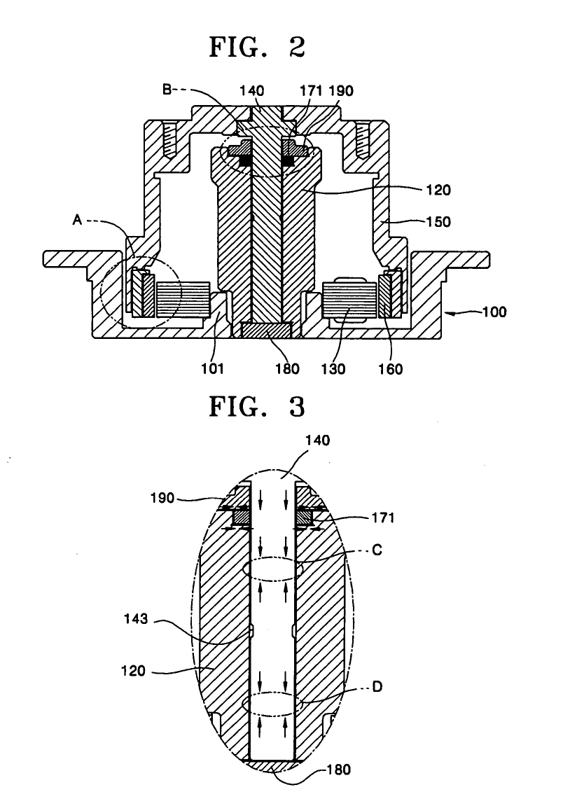

Referring to FIG. 2, the fluid dynamic bearing motor according to the present embodiment of the present invention includes a housing 100 fixing a core 130 wound with a coil and a sleeve 120 having a shaft hole (not shown) at a center portion thereof, a shaft 140 rotatably coupled to the shaft hole to form an oil gap (not shown) therebetween, a hub 150 fixed to an upper end portion of the shaft 140 and having a magnet 160 attached to an inner circumferential surface of the hub 150 and generating an electromagnetic force with the core 130, and a circular thrust plate 171 fixed to an upper portion of the shaft 140.

A flange 101 having a hollow and extending to the inside of the housing 100, in which the core 130 is fixed on an outer circumferential surface thereof, is formed at a center portion of the housing 100. A cover block 180 supporting a lower end portion of the shaft 140 is coupled to an inner circumferential surface of a lower end portion of the sleeve 120.

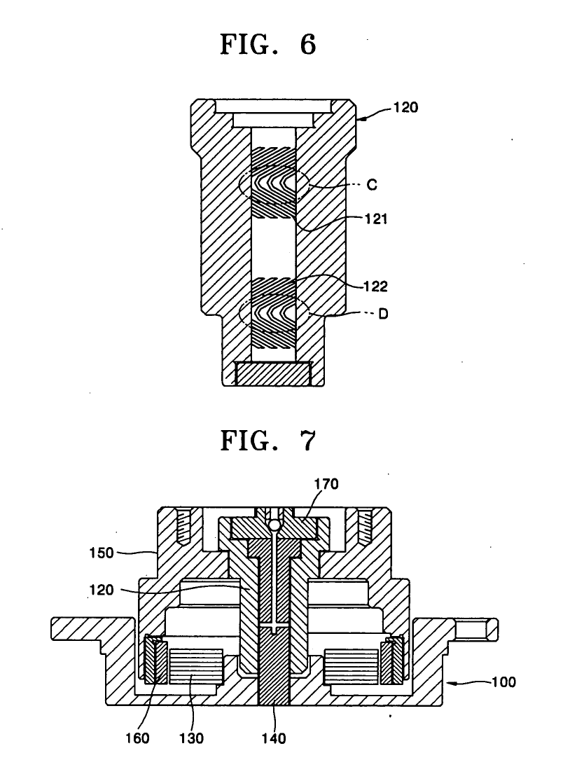

Oil grooves 121 and 122 forming fluid dynamic pressure in a radial direction with the outer circumferential surface of the shaft 140 is formed in the inner circumferential surface of the sleeve 120, as shown in FIG. 6. Oil flowing in the oil grooves 121 and 122 form high dynamic pressure at center portions C and D of the oil grooves 12 and 122, respectively.

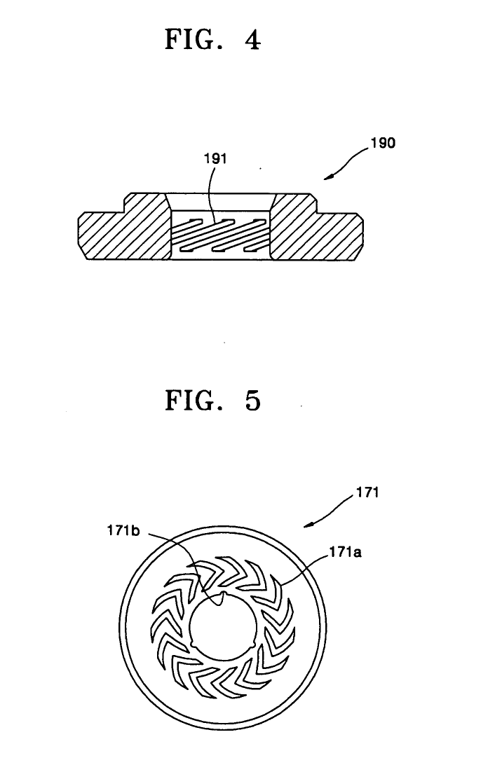

Referring to FIGS. 2 and 4, a cover 190 is provided at the upper end of the inner circumferential portion of the sleeve 120 to increase the internal pressure at a journal portion and prevent leakage of oil. The shaft 140 is rotatably coupled to the cover 190 and forms the oil gap with the upper surface of the thrust plate 171. A plurality of inclined grooves 191 are formed in an inner circumferential portion of the cover 190 at a predetermined interval. Accordingly, when the shaft 140 rotates, the oil filling the inclined grooves 191 of the cover 190 acts as pressure acting downward. Thus, not only the leakage of oil is prevented but also the internal pressure increases, so that generation of the fluid dynamic pressure is stably maintained.

A flow groove 171a forming a passage for oil and generating dynamic pressure is formed in each of the upper and lower surfaces of the thrust plate 171, as shown in FIG. 5. Also, an oil flow groove (not shown) forming a passage for oil and generating dynamic pressure may be formed in a lower surface of the cover 190 and the inner circumferential surface of the sleeve 120, respectively facing the upper and lower surfaces of the thrust plates 171. The flow groove 171a can have a herringbone shape, as shown in FIG. 5, or a spiral shape.

As shown in FIG. 5, a storing groove 171b for storing oil and collecting air bubbles is formed in the inner circumferential surface of the thrust plate 171 between the shaft 140 and the thrust plate 171. The storing groove 171b is disposed at a position where pressure is relatively lower than that of a portion where the fluid dynamic pressure is generated when the shaft 140 rotates, so that the generated air bubbles are smoothly collected.

FIG. 3 shows the flow of oil when the shaft 140 rotates. That is, when the shaft 140 rotates, oil converges at the center protons C and D of the oil grooves 121 and 122 of the sleeve 120 by a dynamic action so that pressure increases while the pressure at a shaft groove 143 of the thrust plate 171 and the shaft 140 decreases. Thus, the oil and the fine air bubbles generated during the rotation of the shaft 140 move toward the thrust plate 171 where the pressure is low and is stored in the storing groove 171b.

In the fluid dynamic bearing motor configured as above, when power is applied to the core 130, the rotor having the shaft 140, the hub 150, and the magnet 160 relatively rotates with respect to the stator having the housing 100, the sleeve 120, and the core 130.

The oil filled between the fixed sleeve 120 and the rotating shaft 140 converges into the oil grooves 121 and 122 forming a high pressure and constituting a fluid dynamic bearing in a radial direction. Also, a fluid dynamic bearing in a thrust direction is formed between the thrust plate 171 and the sleeve 120. The shaft 140 smoothly rotate by the fluid dynamic bearing in the radial direction and the fluid dynamic bearing in the thrust direction.

Since oil pressure acts downward to the inclined groove 191 of the rotating cover 190, the internal pressure between the sleeve 120 and the shaft 140 increases so that the leakage of oil is prevented.

During the driving of the motor, heat is generated by an electromagnetic element A (of FIG. 2) of the core 130 and the magnet 160 and frictional heat is generated by a mechanical element B (of FIG. 2) according to the relative rotation of the thrust plate 171, the cover 190, and sleeve 120 which support a load in the thrust direction. However, since the electromagnetic element A and the mechanical element B are separated from each other, the generated heat is smoothly dissipated. Thus, the deterioration of the oil due to the generated heat is greatly reduced.

FIG. 7 shows a fluid dynamic bearing motor according to another embodiment of the present invention, in which the rotor is rotatably supported by the fluid dynamic bearing with respect to the stator.

Referring to FIG. 7, the stator includes the housing 100, the shaft 140 fixed at the center portion of the housing 100, and the core 130 wound with a coil. The rotator includes the sleeve 120 rotatably coupled to the shaft 140 and supported by a fluid dynamic bearing, a cover block 170 coupled to an upper end of the sleeve 120 and supporting the sleeve 120 in the thrust direction, and the hub 150 coupled to the outer circumferential surface of the sleeve 120 to rotate together and having the magnet 160 installed on the inner circumferential surface of a lower end thereof to face the core 130 and forming an electromagnetic circuit.

In the fluid dynamic bearing configured as above, during the rotation of the hub 150 by the electromagnetic circuit between the core 130 and the magnet 160, fluid dynamic pressure is generated by the oil filling the oil gap between the sleeve 120 and the shaft 140 so that the rotation of the hub 150 is stably supported. Also, the generated heat is smoothly dissipated by installing the cover block 170 where mechanical frictional heat is generated at the upper end portion of the shaft 140, separated from a portion where electromagnetic frictional heat between the core 130 and the magnet 160 is generated.

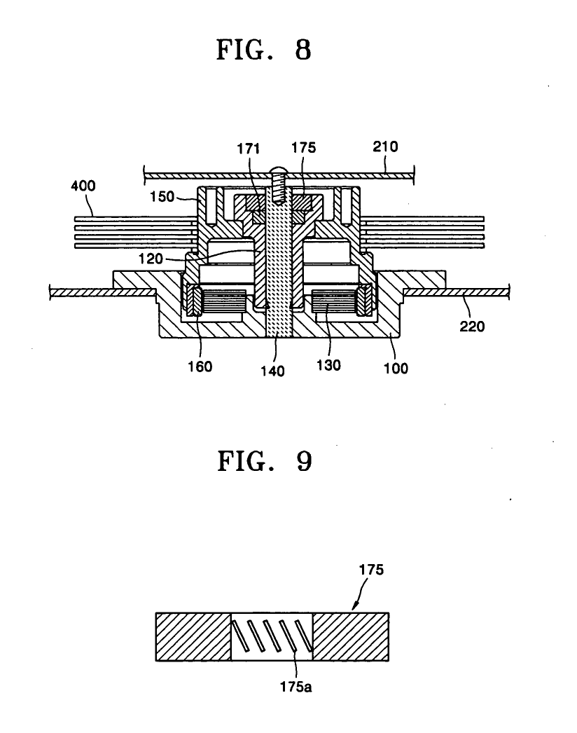

FIGS. 8 and 9 show a fluid dynamic bearing motor according to yet another embodiment of the present invention. In the fluid dynamic bearing motor of the present embodiment, since both ends of the shaft are fixed, when a plurality of platters are mounted on the hub and rotated together, in spite of a large load thereof, a stable driving is possible. Since the heat generating source by an electromagnetic factor and the heat generating source by a mechanical friction are separated from each other, the generated heat is smoothly dissipated.

Also, since the upper end portion of the sleeve to which the shaft is rotatably coupled is finished with the fixing block, the internal pressure of the fluid dynamic bearing portion is increased and the leakage of oil is effectively prevented. Referring to FIG. 8, in the fluid dynamic bearing motor according to the present embodiment, the rotor is rotatably supported by the fluid dynamic bearing with respect to the stator.

The stator includes the housing 100 fixed to a lower fixing body 220, the shaft 140 having a lower end portion fixed at the center portion of the housing 100 and an upper end portion fixed to an upper fixing body 210, a circular thrust plate 171 fixed to the upper end portion of the shaft 140, and the core 130 wound with a coil and fixed to the lower end of the center portion of the housing 100.

The rotor includes the sleeve 120 rotatably coupled to the shaft 140 and supported by the fluid dynamic bearing, a fixing block 175 coupled to the upper end of the sleeve 120 and supporting the sleeve 120 in the thrust direction, and the hub 150 coupled to the outer circumferential surface of the sleeve 120 and rotating together, and having the magnet 160 installed on the inner circumferential surface of the lower end thereof to face the core 130 and forming an electromagnetic circuit.

The upper and lower fixing bodies 210 and 220 may be, for example, a case of a hard disk drive. A flow groove (not shown) having a herringbone shape or spiral shape is formed in the outer circumferential surface of the shaft 140 and the inner circumferential surface of the sleeve 120 so that dynamic pressure is formed between the shaft 140 and the sleeve 120. Also, a flow groove (not shown) having a herringbone shape and a spiral shape is formed in the upper and lower surfaces of the thrust plate 171 and the lower surface of the fixing block 175 and the upper surface of the sleeve 120 facing the same, so that dynamic pressure is generated.

In the shaft fixed type fluid dynamic bearing motor configured as above, both end portions of the shaft 140, which has weak rigidity because of short diameter and length compared to other parts, are fixed, and generation of vibrations due to lowering of rigidity by high speed rotation are prevented by using the hub 150 where a plurality of platters 400 are mounted, as the rotor. Also, by using the shaft 140 as the stator, the rigidity is improved so that a plurality of platters 400 can be mounted and thus a large amount of information can be stored.

In the fluid dynamic bearing motor, when power is applied to the core 130, the rotor including the sleeve 120, the hub 150, and the magnet 160 relatively rotates with respect to the stator including the housing 100, the shaft 140, and the core 130.

The oil filling between the fixed shaft 140 and the rotating sleeve 120 converges into the flow groove (not shown) so that high pressure is formed and thus the fluid dynamic bearing in the radial direction is formed.

The shaft 140 smoothly rotates by the fluid dynamic bearing in the radial direction and the fluid dynamic bearing in the thrust direction. Also, since oil pressure acts downward in an inclined groove 175a of FIG. 9 formed in the inner circumferential surface of the rotating fixing block 175, the internal pressure between the sleeve 120 and the shaft 140 increases and the leakage of oil is prevented.

When the hub 150 is rotated by the electromagnetic circuit between the core 130 and the magnet 160, dynamic pressure is formed by the oil filling the oil gap between the sleeve 120 and the shaft 140 so that the hub 150 is supported capable of stably rotating. Also, since the fixing block 175 and the thrust plate 171 generating mechanical friction heat are installed at the upper end portion of the shaft 140 so as to be separated from the portion where the electromagnetic friction heat is generated by the core 130 and the magnet 160, the generated heat is smoothly dissipated.

While this invention has been particularly shown and described with reference to preferred embodiments thereof, it will be understood by those skilled in the art that various changes in form and details may be made therein without departing from the spirit and scope of the invention as defined by the appended claims.

As described above, the fluid dynamic bearing according to the present invention has the following effects.

First, since the heat generating source due to an electromagnetic factor such as the core and the magnet and the heat generating source due to the mechanical friction between the thrust plate and the sleeve are separated from each other, the generated heat is smoothly dissipated so that the deterioration of oil is reduced. Thus, the lowering of a load support force and an additional friction phenomenon are prevented.

Second, since the cover (fixing block) having the inclined groove forming the dynamic pressure is formed at the upper end portion of the sleeve, the internal pressure between the sleeve and the shaft increases and accordingly the performance of the bearing is improved, so that the leakage of oil due to the high internal pressure is effectively prevented.

Third, since the thrust plate having the storing groove in the inner circumferential surface thereof is installed at the lower pressure portion of the fluid dynamic bearing, the air bubbles generated during the driving of the motor is smoothly collected so that the leakage of oil due to the expanding air bubbles can be effectively prevented.

Fourth, since both end portions of the shaft are fixed and the hub having a plurality of platters is used as the rotor, the generation of vibrations due to the lowering of the rigidity of the rotor occurring during a high speed rotation. Also, by using the shaft 140 as the stator, a plurality of platters can be mounted owing to the improved rigidity so that a large amount of information can be stored.

1. A fluid dynamic bearing motor comprising:
a housing fixing a core wound with a coil and a sleeve having a shaft hole at a center thereof;
a shaft rotatably coupled to the shaft hole and forming an oil gap;
a hub fixed to an upper end portion of the shaft and having a magnet attached to an inner circumferential surface of the hub and generating an electromagnetic force with the core; and
a circular thrust plate coupled to an upper portion of the shaft and forming dynamic pressure in a thrust direction with the sleeve.

2. The fluid dynamic bearing motor as claimed in claim 1, further comprising a cover coupled to the shaft, provided at an upper end of an inner circumferential portion of the sleeve, forming an oil gap with an upper surface of the thrust plate, and having a plurality of inclined grooves formed in an inner circumferential portion thereof at a predetermined interval.

3. The fluid dynamic bearing motor as claimed in claim 1, wherein a flow groove forming a passage for oil and generating dynamic pressure is formed in each of upper and lower surfaces of the thrust plate.

4. The fluid dynamic bearing motor as claimed in claim 2, wherein a flow groove forming a passage for oil and generating dynamic pressure is formed in each of upper and lower surfaces of the thrust plate.

5. The fluid dynamic bearing motor as claimed in claim 3, wherein the flow groove has a herringbone shape.

6. The fluid dynamic bearing motor as claimed in claim 3, wherein the flow groove has a spiral shape.

7. The fluid dynamic bearing motor as claimed in claim 1, wherein a storing groove storing oil and collecting air bubbles is formed in an inner circumferential portion of the thrust plate.

8. The fluid dynamic bearing motor as claimed in claim 2, wherein a storing groove storing oil and collecting air bubbles is formed in an inner circumferential portion of the thrust plate.

9. A fluid dynamic bearing motor in which a rotor is rotatably supported by a fluid dynamic bearing with respect to a stator, wherein the stator comprises a housing, a shaft fixed at a center portion of the housing, and a core wound with a coil and fixed to a lower end of the center portion of the housing, and
the rotator comprises a sleeve rotatably coupled to the shaft and supported by the fluid dynamic bearing, a cover block coupled to an upper end of the sleeve and supporting the sleeve in a thrust direction, and a hub coupled to an outer circumferential surface of the sleeve to rotate together and having a magnet installed on an inner circumferential surface of a lower end thereof to face the core and forming an electromagnetic circuit.

10. A fluid dynamic bearing motor in which a rotor is rotatably supported by a fluid dynamic bearing with respect to a stator, wherein the stator comprises a housing fixed to a lower fixing body, a shaft having a lower end portion fixed at a center portion of the housing and an upper end portion fixed to the upper fixing body, a circular thrust plate fixed to an upper end portion of the shaft, and a core wound with a coil and fixed to a lower end of the center portion of the housing, and
the rotator comprises a sleeve rotatably coupled to the shaft and supported by the fluid dynamic bearing, a fixing block coupled to an upper end of the sleeve, having a flow groove in an inner circumferential surface, and increasing pressure in the fluid dynamic bearing, and a hub coupled to an outer circumferential surface of the sleeve to rotate together and having a magnet installed on an inner circumferential surface of a lower end thereof to face the core and forming an electromagnetic circuit.
